(19) United States
(12) Patent Application Publication
(10) Pub. No.: US 2021/0144449 A1
(43) Pub. Date: May 13, 2021

(54) VIDEO PROCESSING AND MODIFICATION

(71) Applicant: José Antonio CRUZ MOYA, Valencia (ES)

(72) Inventor: José Antonio CRUZ MOYA, Valencia (ES)

(21) Appl. No.: 16/680,137

(22) Filed: Nov. 11, 2019

(51) Int. Cl. H04N 21/81; G06K 9/32; G06K 9/00; G06F 16/783; H04N 21/45

(52) U.S. Cl. CPC H04N 21/812; G06K 9/3241; H04N 21/4532; G06F 16/7844; G06K 9/00744

(57) ABSTRACT

Methods and systems to process video data and modify at least the image portion of the video data real time to alter the image content. In one method, providing a multimedia signal to a processing module; identifying a replaceable area of an image taken from the multimedia signal with a context information; matching, by a client server, a user profile with the context information of the replaceable area; fetching, from an advertising database, a selected advertising content, based on the user profile and the context information; placing the selected advertising content on the replaceable area of the image; and providing a customized multimedia signal to a selected channel, wherein the customized multimedia signal comprises the selected advertising content overlapping, at least in part, an original content of the replaceable area of the image.

### FIELD OF THE INVENTION

The present invention relates to image data processing and more specifically to selective advertising of multimedia content applying image recognition techniques and user preferences.

### BACKGROUND OF THE INVENTION

Nowadays, the advertising industry often resorts to worldwide broadcast events to physically insert advertisement on site. For example, the placement of signs, electronic displays, logos on uniforms, etc. There are many advantages derived from physically placing advertisements, but the limited space is one of the main problems. It is also often difficult to change or update physically installed advertisements.

Advertising companies are often interested on showing their products only to a targeted group of people or a determined geographical area, but generally the owner of the broadcasting, for example, the baseball, soccer, basketball leagues, provides only a single signal (often multimedia) which cannot be adapted to particular needs of advertising companies.

The state of the art addresses the lack of space by physically placing electronic displays that change the advertisements according to time intervals previously set. One problem of these solutions is the heavy and expensive displaying devices, as well as its energy consumption. As well, Electronic display signs can be updated quickly but the change is generally only local.

Moreover, the multimedia signal is normally provided without any personalization options. Sometimes, local advertisements are shown on user's display, but they generally consists on a fix image overlapping the original multimedia content, no matter what part of the image is being hidden. The user experience is terrible in these cases.

Therefore, advertising embedded on multimedia signals is limited to a static scenario, where the images of the original signal include the advertisements placed on site at the moment of recording. This leads the user to some confusion or even some discomfort, for example when the multimedia signal comprises advertisements of products non-available in his country or unknown languages.

Another problem faced by advertising industry refers to how providing targeted advertisement. It is known that the audience of a TV channel is not the same than the audience of an Internet channel and it is also known that the average age of people using mobile devices for consuming multimedia content is lower than the average age of people using static displays. Content providers are aware of that and broadcast different signals meant for different channels, so they can offer different target audiences to advertising companies, based on a selected channel. This redundancy implies a waste of resources and energy.

The state of art is missing a flexible solution for selective advertising, which solves the limitations of known solutions and may be adapted to user preferences keeping a good user experience.

### BRIEF SUMMARY OF THE INVENTION

The following is a summary of the present disclosure in order to provide a basic understanding of some features and context. This summary is not intended to identify key or critical elements of the disclosure or to delineate the scope of the disclosure. Its sole purpose is to present some concepts of the present disclosure in simplified form as a prelude to a more detailed description that is presented later.

In one aspect, the present disclosure can be applied to video (or multi-media) programming or content, for example, programming that comprises a live sporting event, where the event is being broadcast (simultaneously or delayed) over one or more outlets or networks. The networks may in turn broadcast the content to users over, for example, cable television, internet streaming, etc. The broadcast content may be modified using the methods and apparatus described herein. To that extent, the end-user or consumer, for example, a person watching the broadcast on a television or digital device, will see content that is altered from the original scene that the user would have observed were the user (spectator) present in person at the live event.

In some cases, advertising content may be displayed (physically placed) at the live event venue by marketers, advertising agencies or other agents. The physically placed content may appear on signage, billboards (print or electronic), equipment (say, goal posts or benches), uniforms, vehicles, etc. In general, this content is designed and placed in advance of the event, and it does not change during the event, except in limited ways.

One application of the present disclosure is to modify the physically placed advertising. To be clear, the actual advertising content at the venue is not changed. Rather, different advertising content appears inside the broadcast version of the event, as viewed by others who are not present at the time and location of the event. The subject of the broadcast may be a sporting event or any other event such as a concert, convocation, rally, demonstration, etc. These examples are illustrative and not intended to be limiting.

In some embodiments, we refer to generating selective advertising embedded into the original event video. That is, the original event video is modified for re-broadcasting at a different time, location, or over a different distribution channel. As one example, a soccer match played in Barcelona, Spain may be played at a venue where billboards (electronic or printed) advertise wireless phone services in the Catalan language. The original multi-media content generated at the venue (by TV cameras etc.) or generated by studio resources communicatively coupled to TV equipment at the venue, may be modified, optionally in real time, to broadcast the same soccer match, but with different advertisements showing on the billboards during the match. For example, the Catalan advertising may be translated into Spanish for broadcast in other parts of Spain. In another example, entirely different advertisements may be substituted in place of those that appear at the actual venue. Entirely different products or services may be advertised, in a MM broadcast that looks like the original except for the changes in advertising content. As another example, a professional football game may be broadcast throughout the United States, but the advertisements physically placed at the venue may be changed to different content for broadcast (optionally simultaneously) at different parts of the country.

In one aspect, the present disclosure is directed to a method for selective advertising comprising. The method in one example comprises:
a) providing a first multimedia signal to a processing module;
b) determining, by the processing module, at least one replaceable area of a first image taken from the first multimedia signal, wherein said determining comprises identifying a context information of the replaceable area;
c) providing the context information of the replaceable area to a client server;
d) matching, by the client server, a user profile previously uploaded to the client server with the context information provided;
e) sending a request from the processing module to an advertisement database to fetch selected advertising content, based on the user profile and the context information;
f) fetching, from the advertising database, the selected advertising content previously stored;
g) placing, by the processing module, the selected advertising content on the replaceable area of the first image; and
h) providing a customized second multimedia signal to a selected channel, wherein the customized second multimedia signal comprises the selected advertising content overlapping, at least in part, an original content of the replaceable area of the first image.

In some embodiments, determining the replaceable area comprises searching advertisements by a text recognition algorithm running in the processing module in combination with an advertisement database of known commercial brands, to identify portions of text comprising any of the commercial brands included in the advertisement database.

### BRIEF DESCRIPTION OF THE SEVERAL VIEWS OF THE DRAWINGS

To complete the description and in order to give a better understanding of the features of the invention, this specification is accompanied by a set of figures that are an integral part of the same, wherein the following has been represented for illustration purposes and without limitation:

FIG. 1 shows a block diagram of a general scheme of present invention.

FIG. 2 shows one embodiment of the selective advertising system.

FIG. 3 shows a broadcasting of a sport event including some embedded advertisements, which will be the input signal for the present invention.

FIG. 4 shows an image area taken from the input signal of FIG. 3, which has been identified as replaceable.

FIG. 5 shows the original image of FIG. 3, where a selected advertising content replaces the original content of the image.

FIG. 6 shows an alternative replaceable part identified in the original image.

FIG. 7 shows another example of selected advertising content replacing the original content of a replaceable part.

### DETAILED DESCRIPTION OF THE INVENTION

In the following description, at least one embodiment for carrying out the present invention is disclosed in detail with reference to the aforementioned figures. It will be apparent to one skilled in the art that the terms used in the present specification are merely used to describe particular embodiments, and are not intended to limit the present invention. Any expression used in the singular encompasses the expression of the plural, unless it has a clearly different meaning in the context. In the following description, it is to be understood that terms such as “including”, “having”, etc. are intended to indicate the existence of the features, numbers, steps, actions, elements, parts, or combinations, but they are not intended to preclude the possibility that one or more other features, numbers, steps, actions, elements, parts, or combinations may be added.

The present invention solves the aforementioned problems, in one embodiment, by means of a method for selective advertising which comprises the following steps:
a) providing a first multimedia signal to a processing module;
b) determining, by the processing module, at least one replaceable area of a first image taken from the first multimedia signal, wherein said determining comprises identifying a context information of the replaceable area;
c) providing the context information of the replaceable area to a client server;
d) matching, by the client server, a user profile previously uploaded to the client server with the context information provided;
e) sending a request from the processing module to an advertisement database to fetch selected advertising content, based on the user profile and the context information;
f) fetching, from the advertising database, the selected advertising content previously stored;
g) placing, by the processing module, the selected advertising content on the replaceable area of the first image; and
h) providing a customized second multimedia signal to a selected channel, wherein the customized second multimedia signal comprises the selected advertising content overlapping, at least in part, an original content of the replaceable area of the first image.

In one embodiment of the invention, determining the replaceable area comprises searching advertisements by a text recognition algorithm running in the processing module in combination with an advertisement database of known commercial brands, to identify portions of text comprising any of the commercial brands included in the advertisement database.

It is of particular use in the entertainment and advertising industry that multimedia content can be customized to local requirements, overcoming any eventual restriction provided by original multimedia signal.

In one embodiment of the invention determining the replaceable area comprises searching advertisements by an image recognition algorithm running in the processing module in combination with an advertisement database of known commercial logos, to identify parts of the first image comprising any of the commercial logos included in the advertisement database.

In one embodiment of the invention determining the replaceable area comprises:
identifying pixels of the first image with a predetermined color;
comparing a number of adjacent pixels of the identified color with a threshold value; and
in case the number of adjacent pixels of the predetermined color exceeds the threshold value, determining a replaceable area comprising all the adjacent pixels.

Context information may include position information of the replaceable area relative to the first image. According to one embodiment of the invention, the position information is obtained by a set of coordinates defining the replaceable area of the first image. Thus, advantageously, the set of coordinates may be transferred to subsequent images of a video sequence, so the replaceable area is tracked in real time. For example, the set of coordinates may be associated with the advertising content placed on a footballer's t-shirt, which will change its position as the footballer moves around the field, however the selected content is dynamically replacing the original content of the replaceable area in real-time no matter the position of the footballer because the set of coordinates of the replaceable area and the original advertising content move jointly.

Optionally, the context information may include a relevance value for an original content of the replaceable area. Thus, advantageously, each replaceable area may be tagged with the lowest values for areas containing original advertisements and highest values for areas comprising content such as audience of an sport event. In one specific embodiment of present invention, the level of relevance is a criterion for providing with a partial fading to the selected advertising content overlapping the replaceable area. Thus, advantageously, a better user experience is provided, since the selected advertising content does not totally block the original content of the replaceable area.

Selected advertising content is generally based on user profiles and context information of the replaceable area, but according to different embodiment of the invention, the main criteria vary from the selected channel to the geographical location intended for the broadcast of the customized signal.

A second aspect of the present invention refers to a system for selective advertising comprising:
a processing module configured for receiving a first multimedia signal; determining at least one replaceable area of a first image taken from the first multimedia signal, wherein said determining comprises identifying a context information of the replaceable area; providing the context information of the replaceable area to a client server; sending a request to an advertisement database to fetch selected advertising content, based on the user profile and the context information; fetching, from the advertising database, the selected advertising content previously stored; placing the selected advertising content on the replaceable area of the first image; and providing a customized second multimedia signal to a selected channel, wherein the customized second multimedia signal comprises the selected advertising content overlapping, at least in part, an original content of the replaceable area of the first image;
a client server configured for receiving context information of the replaceable area; matching a user profile previously uploaded with the context information provided; and
an advertisement database configured for storing advertising content.

In one embodiment of the invention the processing module is a central server.

Additionally, a switching module may be implemented at the output of the processing module for establishing a connection between said output and the selected channel.

A telecommunication network may be provided to ensure real time communication between the processing module receiving the first multimedia signal and the client server storing user profiles.

A last aspect of present invention refers to a non-transitory machine-readable media storing instructions that when executed by a system, cause the system to perform a method, the method comprising:
a) providing a first multimedia signal to a processing module;
b) determining, by the processing module, at least one replaceable area of a first image taken from the first multimedia signal, wherein said determining comprises identifying a context information of the replaceable area;
c) providing the context information of the replaceable area to a client server;
d) matching, by the client server, a user profile previously uploaded to the client server with the context information provided;
e) sending a request from the processing module to an advertisement database to fetch selected advertising content, based on the user profile and the context information;
f) fetching, from the advertising database, the selected advertising content previously stored;
g) placing, by the processing module, the selected advertising content on the replaceable area of the first image; and
h) providing a customized second multimedia signal to a selected channel, wherein the customized second multimedia signal comprises the selected advertising content overlapping, at least in part, an original content of the replaceable area of the first image.

Therefore, the combination of technical features of present invention implies several technical advantages. For example, user experience is enhanced by offering a transparent non-intrusive solution of placing advertisements.

Energy consumption is benefitted from the processing of a single multimedia signal, which involves less computing load than broadcasting independent signals for each channel or physically placing electronic displays on site.

Moreover, present invention can be easily and quickly adapted to any user, who is barely required to provide a set of preferences in his user profile and storing some advertising content to the data base.

FIG. 1 illustrates a block diagram of a general scheme of present invention, where an original multimedia signal (1) is provided as an input signal to the selective advertising system (2) of present invention. The selective advertising system modifies the original multimedia signal and provides an output signal (3), which includes the original multimedia signal customized based on commercial policies of the user. The output signal is provided through a selected channel (4), for example IPTV (5), TDT (6), Internet (7), etc.

FIG. 2 illustrates one embodiment of present invention, where the selective advertising method comprises the following steps.

Firstly, selecting an input signal, provided from an available multimedia content source (11, 12, 13) to a processing module (24). Multimedia content may be provided in a TV signal, recorded video, web, IPTV . . . .

Once the input signal is selected, present invention processes an original image captured from the selected signal. An image recognition algorithm running on the processing module (24) identifies different parts of the captured original image following a criterion which distinguishes replaceable parts (26) of captured image from non-replaceable parts (25). Replaceable parts may be determined based on different criteria set by the user, for example, areas identified as comprising an advertisement, areas identified as only comprising audience of a sport event or TV contest or areas of the image identified as only showing the sky.

The original image is provided, including information of replaceable parts and some context information, to a server (29) hosting artificial intelligence (AI) algorithm, which matches the original image with a determined user profile. User profiles are previously uploaded to the server and each profile defines a commercial policy of the user and technical preferences for advertising.

User profiles may contain information about geographical preferences, distribution channels, size of the available replaceable areas, location of the replaceable area in the displaying device and many other technical and commercial criteria.

The context information provided to the server may include, for example, position information of the replaceable area relative to the first image. Position information is obtained by a set of coordinates defining the replaceable area of the first image. The set of coordinates may be transferred to subsequent images of a video sequence, so the replaceable area is tracked in real time.

Responsive to the matching step carried out by the server (29), the processing module extracts replaceable parts (26) from the original image and replaces said parts with a selected content (27) taken from an advertisement database (28) of multimedia content, based on the user profile and context information. Therefore, a new image (30) is generated by the processing module, which is a copy of the original image, but the replaceable parts have been replaced with the advertising content selected for the user.

The new image (30) is then provided to a telecommunication channel (11′,12′, 13′), so the output signal of present invention finally distributes a customized version of original image with the advertising content selected for the user. Thus, the new image (30) provided by present invention is modified based on the commercial parameters defining different user profiles, such as geographic distribution area, target customer, specific public, etc.

FIG. 3 illustrates a particular embodiment of present invention, where the broadcasting of a sport event includes some embedded advertisements (31). Once the original multimedia signal is provided to the processing module of the selective advertising system of present invention, the recognition algorithm running on the processing module identifies commercial logos and commercial brands. Replaceable and non-replaceable parts of the image are identified, as shown in FIG. 4, where an area (41) has been identified as “replaceable”. The original multimedia signal, including information of replaceable parts, is provided to the client server, where artificial intelligence algorithms match it with a determined user profile. The processing module extracts replaceable part (41) from the original image and replaces said part with a selected content (51) taken from the advertisement database, based on the user profile, as shown in FIG. 5.

Geographical area may be one of the main criteria of user commercial policies. Users' profiles often depend on geographical areas for selecting one advertising or another. For example, worldwide broadcasting of a sport event, as shown in previous figures, may offer a customized video signal based on local preferences of users, such as local brands or local celebrities.

FIG. 6 illustrates one embodiment of the invention where, alternatively or in combination with the embodiment of FIG. 5, it is chosen a different replaceable part of the original image to insert selected advertisements. In this case, a couple of areas (61, 62) have been identified as only comprising audience. Following a given criterion which identifies parts having audience of a sport event as replaceable parts, the original multimedia signal, including the information of replaceable parts, is provided to the client server, where artificial intelligence algorithms match it with a determined user profile. Then, the processing module overlaps the replaceable area with a selected content (51) taken from the advertisement database, based on the user profile. Optionally, the selected content is partially faded in order to provide a smooth visual effect combining the audience of the original image with selected advertising content.

In one embodiment of present invention, the processing module (24) distinguishes replaceable parts from non-replaceable parts based on a color criterion. For example, finding high numbers of adjacent pixels of a same color may define an area, which can be a replaceable area in case of blue color (assuming that the area only shows the sky) or a non-replaceable area in case of green color (assuming that the area shows the game field of a sport event). A threshold may be set to avoid areas that are too small.

The selective advertising method of present invention allows customizing the advertising of an original multimedia signal depending, for example, on the distribution channel. Therefore, a same TV show may include traditional advertisements for a standard TV channel, but in contrast may include specific advertisements targeted to young people when the same TV show is distributed through an Internet channel.

FIG. 7 illustrates one embodiment of the invention where, starting from the same original multimedia signal than FIG. 3 and same segmentation of the original image into replaceable and non-replaceable parts, the processing module replaces the replaceable part with a selected content (71) taken from the advertisement database, based on the user profile. In this case, the user profile gives high importance to the displaying device, which in FIG. 7 is a smartphone (72), so the selected content 71 is different from the selected content 51 of FIG. 5.

In one embodiment of the invention, replaceable parts are identified by comprising text advertisements. Namely, text recognition software is provided in combination with an advertisement database of known commercial brands. Processing module carry out a search to identify eventual portions of text comprising any of the commercial brands included in the advertisement database.

In one embodiment of the invention, replaceable parts are identified by comprising graphical advertisements. Namely, image recognition software is provided in combination with an advertisement database of known commercial logos. Processing module carries out a search to identify eventual parts of the image comprising any of the commercial logos included in the advertisement database.

Optionally, present invention can also be applied for parental control. Instead of totally blocking a multimedia signal containing inappropriate content, the software running on the processing module of present invention defines the area containing inappropriate content, according to a certain user profile (such and gambling information, telephone numbers or keywords related with TV contests, horoscopes, tarot cards . . . ), so the area can be replaced by a selected content stored in the advertising database.

The processing module may be implemented on a processor, microprocessor, a server, a web server, a computer or the cloud. The algorithms disclosed to implement the processes of present invention may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects. A person skilled in the art will be aware that the various embodiments are capable of being distributed as a program product in a variety of forms, and that the disclosure applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks (DVDs), etc.), among others, and transmission type media such as digital and analogue communication links.

The present invention is not limited by the embodiment disclosed herein. Other embodiments can be made by persons skilled in the art in light of this description. In consequence, the scope of the invention is defined by the following claims.

1. A method comprising:
receiving a first multimedia input signal to a processing module wherein the first multimedia input signal comprises a series of images captured at a physical venue;
determining, by the processing module, a first image of the input signal that has a replaceable area and determining the replaceable area of the first image;
wherein said determining comprises identifying a context information of the replaceable area;
providing the first image, the replaceable area, and the context information of the replaceable area to a client server;
matching the first image, by the client server, to a user profile previously uploaded to the client server;
sending a request from the processing module to an advertisement database to select advertising content, based on the matched user profile and the context information;
fetching, from the advertisement database, the selected advertising content;
by the processing module, replacing the replaceable area of the first image with the selected advertising content so as to generate a new image;
identifying additional images in the series that have replaceable areas and replacing the replaceable areas of each of the additional images with the selected advertising content so as to generate additional new images;
generating a customized second multimedia signal, wherein the customized second multimedia signal includes the new image and the additional new images; and
providing the second multimedia signal through a selected channel.

2. The method of claim 1 wherein determining the replaceable area of the first image comprises recognizing text in the image by a text recognition algorithm running in the processing module and querying a first advertisement database of known commercial brands based on the recognized text, to identify any matching commercial brands.

3. The method of claim 1 wherein determining the replaceable area of the first image comprises searching advertisements by an image recognition algorithm running in the processing module in combination with a second advertisement database of known commercial graphic images, to identify parts of the first image comprising any of the known commercial graphic images included in the second advertisement database.

4. The method of claim 1 wherein determining the replaceable area of the first image comprises:
identifying adjacent pixels of the first image that all have a predetermined color;
comparing a number of the identified adjacent pixels to a threshold value; and
in case the number of identified adjacent pixels exceeds the threshold value, determining a replaceable area comprising all the identified adjacent pixels.

5. The method of claim 1 wherein identifying the context information includes obtaining a position information of the replaceable area relative to the first image.

6. The method of claim 5 wherein obtaining the position information comprises obtaining a set of coordinates defining the replaceable area of the first image.

7. The method of claim 1 wherein identifying the context information includes determining a relevance value for an original content of the replaceable area.

8. The method of claim 7 wherein generating the customized second multimedia signal further comprises partially fading the selected advertising content, based on the relevance value determined for the original content of the replaceable area.

9. The method of claim 1 further comprising selecting the advertising content based on the selected channel.

10. The method of claim 1 further comprising selecting the advertising content based on at least one parameter provided in the matched user profile.

11. A system for selective advertising comprising:
a processing module configured for receiving a first multimedia input signal that includes at least one image;
the processing module including image processing software executable to carry out the steps of—
determining a first image of the input signal that has at least one replaceable area;
and determining the replaceable area of the first image wherein said determining the replaceable area comprises identifying a context information of the replaceable area;
a matching component coupled to the processing module to receive the context information of the replaceable area;
the matching component arranged to match the first image with a user profile previously stored;
an advertising component coupled to an advertisement database that stores advertising content;
wherein the processing module is arranged to:
send a request to the advertising component to query the advertisement database to select advertising content, based on the user profile and the context information;
fetch from the advertising database, the selected advertising content;
place the selected advertising content on the replaceable area of the first image so as to form a customized output signal, wherein the customized output signal comprises the selected advertising content overlapping, at least in part, an original content of the replaceable area of the first image;
a switching module coupled to the processing module and arranged to distribute the customized output signal over a selected channel, wherein the channel is selected based on the matched user profile.

12. The system of claim 11 wherein the matching component hosts an artificial intelligence (AI) module configured for matching the first image with a user profile previously uploaded to the server.

13. (canceled)

14. The system of claim 11 further comprising a telecommunication network configured for providing real time communication between the processing module receiving the first multimedia input signal and the server storing user profiles.

15. (canceled)

16. A method comprising:
receiving a multimedia input signal at a processing module, wherein the multimedia input signal comprises a series of images;
in the processing module, executing the steps of—
analyzing each of the series of images to detect advertising content if there be advertising content visible in the image;
for an image in which advertising content is detected, matching the detected advertising content to a user profile;
designating as a replaceable area a region in the image that includes the detected advertising content;
determining a set of coordinates that define a location of the replaceable area in the image;
based on the set of coordinates, tracking location of the replaceable area in subsequent images of the series of images;
selecting replacement image content, based on the matched user profile;
in the processing module, placing the replacement images content in the replaceable area in each of the subsequent images so as to form a customized second multimedia signal; and
providing the customized second multimedia signal to a selected telecommunication channel for broadcasting to end-users.

17. The method of claim 16 wherein analyzing an image to identify advertising content visible in the image comprises searching advertisements by a text recognition algorithm running in the processing module in combination with an advertisement database of known commercial brands, to identify portions of text comprising any of the commercial brands included in the advertisement database.

18. The method of claim 16 including:
comparing dimensions of the selected replacement image content to the dimensions of the replaceable area; and
modifying the selected replacement image content to fit the replaceable area.

19. The method of claim 16 including:
detecting an image area that contains inappropriate content based on information in the matched user profile; and
replacing the image area that contains inappropriate content by a selected content stored in the advertising database.

20. The method of claim 10 wherein the user profile parameters include at least one of gender, age, geographic location, preferred distribution channels, size of the available replaceable areas, location of the replaceable areas, and preferred display device.
